(19) United States
(12) Patent Application Publication
(10) Pub. No.: US 2006/0138688 A1
(43) Pub. Date: Jun. 29, 2006

(54) Moulding of concrete articles

(76) Inventor: Graeme Reginald Hume, Werribee (AU)

Correspondence Address: CONNOLLY BOVE LODGE & HUTZ LLP, SUITE 800, 1990 M STREET NW, WASHINGTON, DC, 20036-3425, US

(21) Appl. No.: 10/535,100

(22) PCT Filed: Nov. 17, 2003
(86) PCT No.: PCT/AU03/01522

§ 371 Date: May 16, 2005

(30) Foreign Application Priority Data
Nov. 18, 2002 (AU) 200295761

(51) Int. Cl. E04B 1/16; B28B 7/28; B28B 3/00

(52) U.S. Cl. 264/35; 249/177; 264/333

(57) ABSTRACT

A plant for moulding and curing elongated concrete products such as poles piles and pipes which includes at least one vertical mould, support means above the mould to suspend the reinforcing material in the mould, pump means to fill the mould with concrete so that the elongated product forms around the reinforcing material. A vertical curing carousel adapted to vertically suspend the moulded elongated product is associated with each mould. A lifting apparatus is used to lift reinforcing material into the vertical mould, to remove the formed product from the mould, to place it on the curing carousel and to remove it from the carousel when the product is sufficiently cured for storage. The products incorporate a reinforcing mesh which is suspended in the mould from at least two attachment points so that a portion extends from the top of the mould. A flexible link is used to attach the reinforcing mesh to the attachment points to reduce the likelihood of relevant movement between the reinforcing and the moulded concrete during removal and transfer from the mould.

This invention relates to improvements in the moulding of concrete articles such as poles, piles or pipes in a vertical mould and particularly to the layout of a production plant and the means of transporting moulded articles during moulding and curing.

### BACKGROUND TO THE INVENTION

In producing precast concrete products the size and weight of the products means that the plant must be sized to accommodate cranes and transport to move the products from the mould to a curing station and then to a storage area for transport. For long concrete products such as poles, piles or pipes the land area taken up for moulding curing and storing is quite large and taking into consideration the capital cost of land this can affect the economic viability of a plant.

After moulding all precast concrete articles need to be moved. U.S. Pat. No. 5,242,249 discloses a means for lifting a precast panel which incorporates a precast insert that is hooked to the reinforcing in the panel. U.S. Pat. No. 4,992,005 discloses an alternative fixed attachment for retaining wall panels which is precast into the panel.

The moulding of concrete pipes, hollow poles or piles in a vertical mould has been proposed in U.S. Pat. Nos. 4,996,013 and 6,284,172. The mould is filled from the bottom and the concrete is compressed between an inner and outer mould by moving the inner mould outwardly using a flexible membrane. The moulded pole is supported by the reinforcing cage when it is moved from the mould to the curing station. When the weight of the freshly cast pole is transferred from the mould to the reinforcing cage as a preliminary step to removing the moulded product, cracking can occur. Relative movement can occur because of a change in the alignment between the reinforcing cage and the concrete in the mould. When the product is lifted from the mould by the reinforcing cage slight differences in the position of the support points can cause a change in the shape of the cage and this in turn can cause cracking of the freshly moulded concrete. These patents had not addressed the need to design a plant for continuous production of poles

It is one object of this invention to provide an economic plant for the continuous production of long concrete articles such as poles, pipes and piles. It is an object of this invention to provide a means of avoiding cracking during lifting and transfer of the moulded article from the mould.

### BRIEF DESCRIPTION OF THE INVENTION

To this end the present invention provides a plant for moulding and curing elongated concrete products which includes
a) at least one vertical mould
b) support means above the mould to suspend the reinforcing material in the mould
c) pump means to fill the mould with concrete so that the elongated product forms around the reinforcing material
d) a vertical curing carousel adapted to vertically suspend the moulded elongated product
e) a lifting apparatus adapted to lift reinforcing material into the vertical mould, to remove the formed product from the mould, to place it on the curing carousel and to remove it from the carousel when the product is sufficiently cured for storage.

By using a vertical mould the footprint of the production plant is reduced with a resultant saving in land area. The other consequence of using a vertical mould and moving the vertically suspended product to an adjacent carousel for curing is that the number of operators needed can be kept to a minimum because they are able to easily inspect the suspended poles from a centrally located work platform. Preferably a minimal plant layout utilizes a single central support mast which supports a work platform and two vertical moulds. Associated with each mould is a curing carousel. The curing carousel has a sufficient number of product suspension points to enable a product to cure by the time the carousel has rotated at least 360°. The number of stations on each carousel is equivalent to the time required to sufficiently cure the concrete divided by the time required to insert the reinforcing in the mould, fill the mould with concrete and dewater the concrete so that the product is able to be removed from the mould. In one embodiment of the invention each carousel has 18 stations and 9 hours is needed to cure the concrete and the moulds can be filled and the product removed in half an hour.

To raise the reinforcing cages a lifting truss is used that is pivoted at one end adjacent the vertical mould so that reinforcing cages can be attached to the truss in its horizontal position and raised to the vertical for insertion into the mould. Moulded products can be lowered from the vertical to the horizontal position by the truss so that they can be transported in the horizontal position.

In another aspect the present invention provides a method of forming elongated concrete products in which
a) the products are formed in a vertical mould
b) the products incorporate a reinforcing mesh a portion of which extends from the top of the mould
c) the reinforcing mesh is suspended in the mould from at least two attachment points
d) a flexible link is used to attach the reinforcing mesh to the attachment points to reduce the likelihood of relevant movement between the reinforcing and the moulded concrete during removal and transfer from the mould.

In one embodiment of the invention the product is a hollow pole or pile of square, circular or elliptical cross section which may be of constant or reducing cross section. The reinforcing mesh is of similar shape and fits within an annular mould space. A portion of the reinforcing cage extends above the mould so that it can be attached to the support means. It is preferred to use a support ring that is supported on brackets above the mould and transferable to brackets on the curing station. The support ring has at least two flexible chains which hang from two equidistant points on the ring. These flexible links allow relative movement between the ring and the cage but do not effect alignment between the cage and the concrete.

The support ring stays with the reinforcing cage from the time the reinforcing is first suspended in the mould until the elongated concrete product is cured after which the support ring is detached from the extension of the reinforcing frame and reused.

### DETAILED DESCRIPTION OF THE INVENTION

A preferred embodiment of the invention useful in the manufacture of hollow poles, piles or pipes is illustrated in the drawings in which:

FIG. 1 is a side elevation of a first embodiment of a plant according to this invention;

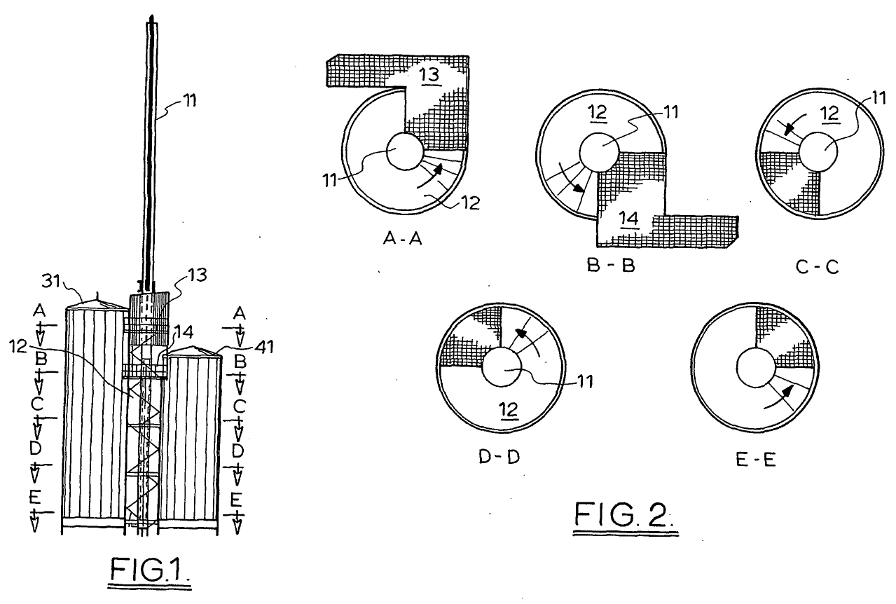

FIG. 2 is a series of plan views taken at five elevations in FIG. 1;

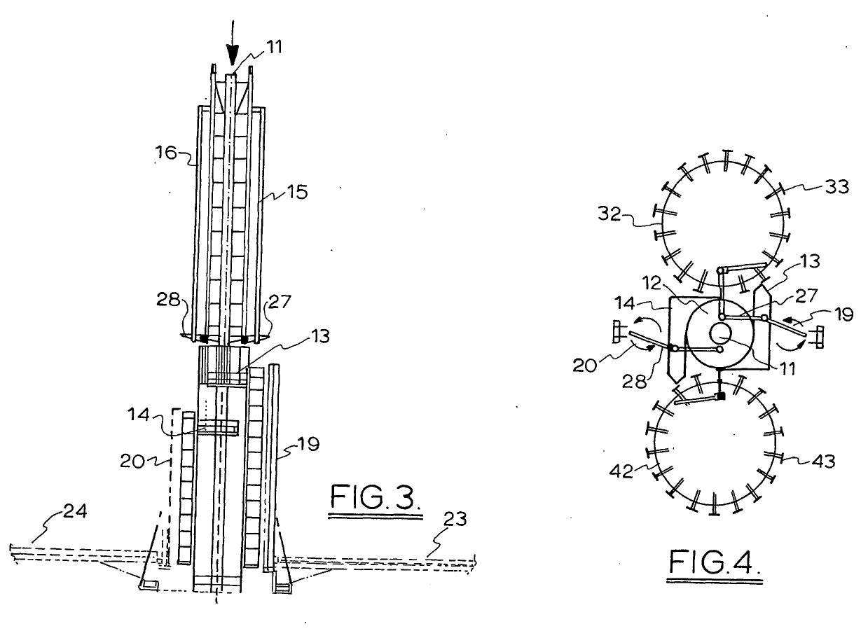

FIG. 3 is a side elevation of the central mast of the plant as shown in FIG. 1;

FIG. 4 is a plan view of the mast and carousels of the plant of FIG. 1;

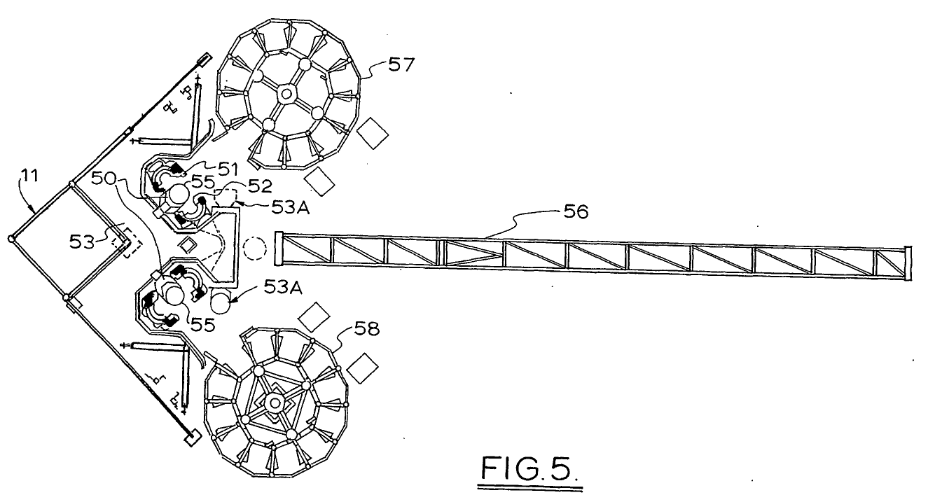

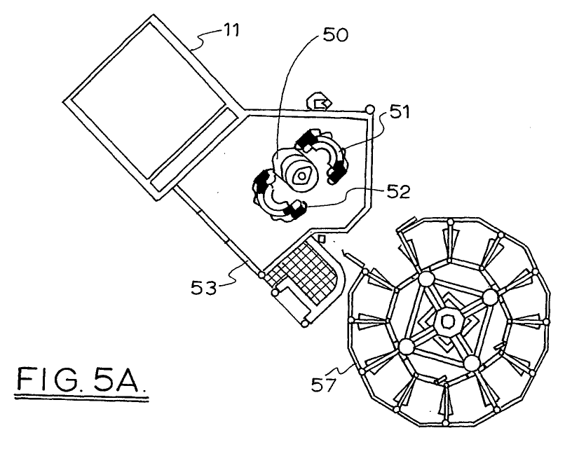

FIG. 5 is a plan view of another two mould plant layout in accordance with this invention and FIG. 5A is a single mould layout;

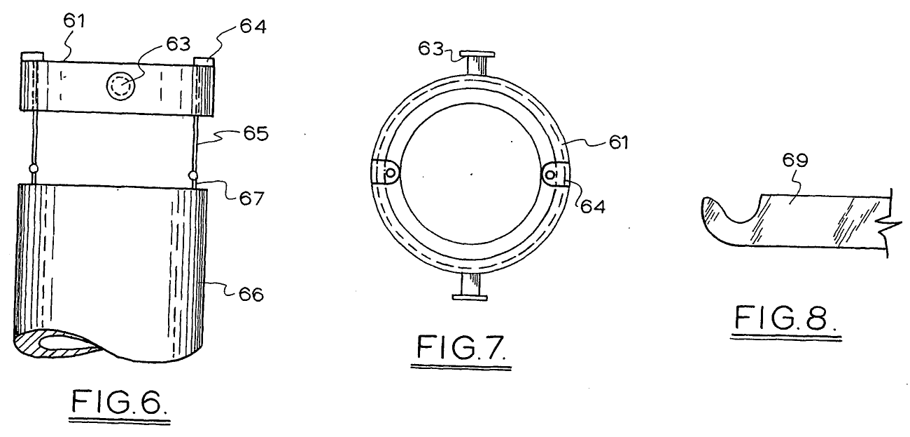

FIG. 6 is a side elevation of the carrying system used in transporting the reinforcing cages and moulded products;

FIG. 7 is a plan view of the carry ring of FIG. 6;

FIG. 8 is a view of a support bracket for the support ring of FIG. 7.

The plant as shown in FIGS. 1 to 4 has a central mast 11 supporting two moulds one to make 12 metre poles and the other to make 9 metre poles.

The central mast 11 has a spiral staircase 12 leading to the work platform 13 for the 12 metre poles and to platform 14 for the 9 metre poles.

The moulds are inverted relative to the poles and the moulds 19 and 20 for forming the poles are located at the base of mast 11 and extend up to the appropriate work platform 13 and 14. The mould cores are held at the top of the mast and are lowered via the guide rails 15 and 16 into the moulds to define a vertical long annular mould space. The detail of the mould construction is the same as that described in U.S. Pat. No. 6,284,172 the contents of which are herein incorporated by reference. The mould may be hinged on one side with a series of wedge clasps on the other at centres of 300 to 750 mm apart mounted on a vertical steel column. The column is operated by two hydraulic cylinders. An alternate embodiment has the wedge fastening on both sides so that the mould shells remain parallel when being removed from the freshly moulded concrete articles. The sequence of steps in closing the mould may be
1. close mould around reinforcing cage and lock
2. lower core down through centre of cage
3. raise the column and lock
4. close the mould caps

Steps 1 and 2 can be reversed and steps 3 and 4 may be simultaneous. To avoid damage to the core the cage needs to be centred with the core during installation. The reinforcing cages for the poles are raised upside down into position by the raising trusses 23 and 24 and then lifted into the mould space using the articulated lifting beams 27 and 28. The reinforcing cage 67 is attached to a support ring 61 as shown in FIGS. 6 and 7 by the flexible links 65 that hang from the link mounts 64. The ring 61 is supported on the bracket mounts 63 by the brackets 69 shown in FIG. 8. These brackets are located on the central mast 11 about 300 mm above the top of the mould. The link mounts and the bracket mounts are at right angles to each other and the flexible links 65 include at least one pivot point so that there is little likelihood of relative movement between the reinforcing 67 and the concrete of the pole 66.

After the mould has been filled with concrete and the concrete dewatered in accordance with the procedure described in U.S. Pat. No. 6,284,172 the mould is opened in the following sequence
1. remove the top mould cap
2. split the concrete at the bottom
3. lower the column
4. raise the core
5. open the mould.

The formed poles, supported by the support ring 61 are transferred to the support hooks 33 or 43 by the lifting beams 27 and 28.

Associated with each mould are curing carousels 31 for the 12 metre pole and 41 for the 9 metre poles. These carousels are fabricated from steel sections to form individual pole curing compartments which are insulated. The insulation is preferably foamed polystyrene/steel sandwich panels. Each pole compartment is wedged shape with doors on the external wall. The carousel may contain 12 compartments. Preferably the number of positions on each carousel corresponds to the curing time divided by the moulding time for each pole.

The carousels are rotated manually or hydraulically using a ratchet system. The bearings for the carousels may be a large antifriction bearing a large sliding bearing or a central spherical bearing. When a pole first enters the compartment the doors are closed and the compartment is heated to raise the temperature to about 65° C. Preferably the compartment is then subjected to steam for about 2 hours followed by a cooling down period of up to 2 hours by which time the carousel will have completed one rotation and the pole is cured sufficiently to be removed for transport.

In an alternate embodiment the lifting beams for the reinforcing cage may be separate from those used for lifting the moulded poles.

A different plant layout is shown in FIGS. 5 and 5A. Again a single mast 11 supports a work platform 53. An access staircase is adjacent the mast. Two casting stations 50 are used and the mould halves 51 and 52 are shown. The reinforcing cages are moved into the work area in a horizontal position and laid on the lifting truss. The reinforcing cage is raised using the truss 56 which is pivoted adjacent the base of the mast below the centre front of the work platform 53 and the lifting beam 54 and has hydraulic lifting rams (not shown). The cage is transferred from the truss to a holding station 53A. The truss 56 is also used to remove the formed poles 55 when they are cured. The curing carousels 57 and 58 are similar to the carousels of FIGS. 1 to 4 and using the same carrying ring as described for FIGS. 6 to 8. An articulated lifting beam 54 transfers the reinforcing to the moulds, the moulded poles to the carousels and then the cured poles 55 back to the truss 56 for removal to the storage and transport section of the plant. The lifting beam or crane 54 is guided to each pick up and delivery point by a programmable logic controller.

The operating sequence of the plant shown in FIG. 5 A is as follows:
1. A cured pole is picked up by crane 54 and delivered to the vertical truss which lowers it to the ground where it is transferred in the horizontal position to a transporter
2. A reinforcing cage is then placed on the truss and raised for pick up by the crane
3. After delivering the cured pole the crane returns to the casting station 50 and carries a freshly cast pole to the curing station from which the hardened pole was removed. The carousel is the rotated to bring the next cured pole up to the transfer location.
4. The crane then moves to remove a reinforcing cage from the holding position 53A to the casting station 50. The operation of the mould is as described above.
5. the crane then removes the reinforcing cage from the truss 56 and places it on the holding station 53A
6. these steps are then repeated for the second casting station.

It is possible for one operator to operate the crane and to control the closing filling dewatering and opening of the moulds.

The casting plant of this invention has the following advantages
smaller land area required
greater production rate in terms of poles per hour
greater productivity in terms of poles per man hour
ability of the plant to be dismantled transported and reassembled

Those skilled in the art will realize that the invention may take many forms, apart from the embodiments described above.

1. A plant for moulding and curing elongated concrete products which includes
a) at least one vertical mould
b) support means above the mould to suspend the reinforcing material in the mould
c) pump means to fill the mould with concrete so that the elongated product forms around the reinforcing material
d) a vertical curing carousel adapted to vertically suspend the moulded elongated product
e) a lifting apparatus adapted to lift reinforcing material into the vertical mould, to remove the formed product from the mould, to place it on the curing carousel and to remove it from the carousel when the product is sufficiently current for storage.

2. A plant as claimed in claim 1 in which two moulds are used and the a lifting apparatus is positioned between the two moulds and a curing carousel is located adjacent each mould.

3. A plant as claimed in claim 1 in which the curing carousel has a sufficient number or product suspension points to enable a product to cure by the time the carousel has rotated at least 360°.

4. A plant as claimed in claim 1 in which the reinforcing mesh is suspended in the mould from at least two attachment points and a flexible link is used to attach the reinforcing mesh to the attachment points to reduce the likelihood of relevant movement between the reinforcing and the moulded concrete during removal and transfer from the mould.

5. A plant as claimed in claim 4 in which a support ring with at least two flexible chains hang from two equidistant points on the ring is used as the flexible link with the chains being attached to the reinforcing cage.

6. A plant as claimed claim 1 in which a lifting truss is used that is pivoted at one end adjacent the vertical mould so that reinforcing cages can be attached the truss in its horizontal position and raised to the vertical for insertion into the mould and moulded products can be lowered from the vertical to the horizontal position by the truss so that they can be transported in the horizontal position.

7. A method of forming elongated concrete products in which
a) the products are formed in a vertical mould
b) the products incorporate a reinforcing mesh a portion of which extends from the top of the mould
c) the reinforcing mesh is suspended in the mould from at least two attachment points
d) a flexible link is used to attach the reinforcing mesh to the attachment points to reduce the likelihood of relevant movement between the reinforcing and the moulded concrete during removal and transfer from the mould.

8. A method as claimed in claim 6 in which the attachment means is used to suspend the moulded product when it is removed from the mould and placed in a vertical curing station.

9. A method as claimed in claim 6 in which the reinforcing cage is raised from the horizontal to the vertical using a truss pivoted at a point adjacent the bottom of the mould and the truss is also used to lower the moulded product from the vertical to a horizontal position for transport.
